(19) United States
(12) Patent Application Publication
(10) Pub. No.: US 2011/0070831 A1
(43) Pub. Date: Mar. 24, 2011

(54) COUPLER AND COMMUNICATION SYSTEM

(75) Inventor: Takuya Nagai, Nagoya-shi (JP)

(73) Assignee: BROTHER KOGYO KABUSHIKI KAISHA, Nagoya-shi (JP)

(21) Appl. No.: 12/873,409

(22) Filed: Sep. 1, 2010

(30) Foreign Application Priority Data
Sep. 18, 2009 (JP) 2009-216629

(51) Int. Cl. H04B 5/00; H01F 5/00

(52) U.S. Cl. 455/41.1; 336/200

(57) ABSTRACT

There are provided a coupler and a communication system including a primary antenna; and the coupler provided between the primary antenna and a plurality of secondary antennas. The coupler includes a substrate which configures a coupler main body, a first coil antenna which is connected to a first secondary antenna and provided on a first surface side of the substrate, and a second coil antenna which is connected to a second secondary antenna and provided on a second surface side of the substrate. The first coil antenna and the second coil antenna are configured so as to have a same degree of electromagnetic coupling with respect to the primary antenna.

### CROSS-REFERENCE TO RELATED APPLICATION

This application claims priority from Japanese Patent Application No. 2009-216629, filed on Sep. 18, 2009, the entire subject matter of which is incorporated herein by reference.

### TECHNICAL FIELD

Aspects of the present invention relate to a coupler that couples a plurality of secondary antennas to a communication device having a primary antenna, and a communication system thereof.

### BACKGROUND

A related-art communication device transmits power or a signal in a non-contact manner by electromagnetic induction or radio waves. As such a communication device, for example, there is known a radio frequency identification (hereinafter referred to as an “RFID”) system which includes a wireless tag communication device that performs transmission/reception of information with respect to a wireless tag circuit element that can store information.

In some type of business such as sales, logistics or the like, this RFID system is used in clearance work on goods in stock, which is periodically performed to confirm the goods in stock, in searches for specified goods, and the like. In such goods management, in order to facilitate transmission/reception of information between a non-contact type data carrier terminal and a wireless tag provided on a goods item and to improve work efficiency, a plurality of external antennas are provided separately from an internal antenna provided in the non-contact type data carrier terminal.

Specifically, for example, two external antennas for the non-contact type data carrier terminal are provided on the left and right working gloves, respectively. When a goods item is grasped with both hands, a distance between the wireless tag provided on the goods and the external antennas becomes smaller, and thus, the transmission/reception of a signal such as identification information or the like can be easily performed.

However, when performing transmission/reception of information with a wireless tag using the working gloves provided with the external antennas as described above, if signals transmitted from the respective external antennas do not have the same signal level, a difference occurs in the communication range for each external antenna. As a result, when performing a read operation to a wireless tag using the working gloves, there may occur the case where the external antenna provided on the right-handed glove can read a wireless tag, whereas the external antenna provided on the left-handed glove cannot read a wireless tag. In this case, since a worker typically does not care such difference in communication range, reception omission may occur.

### SUMMARY

Accordingly, it is an aspect of the present invention to provide a coupler and a communication system, which can make a communication range of a plurality of secondary antennas substantially equal to each other, which are coupled to a primary antenna provided on the communication device by the coupler.

According to an illustrative embodiment of the present invention, there is provided a coupler to be provided between a primary antenna provided in a communication device and a plurality of secondary antennas. The coupler includes: a substrate which configures a coupler main body; a first coil antenna which is connected to a first secondary antenna and provided on a first surface side of the substrate; and a second coil antenna which is connected to a second secondary antenna and provided on a second surface side of the substrate, wherein the first coil antenna and the second coil antenna are configured so as to have a same degree of electromagnetic coupling with respect to the primary antenna.

According to another illustrative embodiment of the present invention, there is provided a coupler to be provided between a primary antenna provided in a communication device and a plurality of secondary antennas. The coupler includes: a substrate which configures a coupler main body and includes a first surface and a second surface; a first coil antenna which is connected to a first secondary antenna and includes a first portion provided on the first surface side and a second portion provided on the second surface side; and a second coil antenna which is connected to a second secondary antenna and includes a first portion provided on the first surface side and a second portion provided on the second surface side, wherein the first coil antenna and the second coil antenna are configured so as to have a same degree of electromagnetic coupling with respect to the primary antenna.

According to a further illustrative embodiment of the present invention, there is provided a communication system including: a communication device including a primary antenna configured to transmit and receive information; and a coupler provided between the primary antenna and a plurality of secondary antennas. The coupler includes: a substrate which configures a coupler main body; a first coil antenna which is connected to a first secondary antenna and provided on a first surface side of the substrate; and a second coil antenna which is connected to a second secondary antenna and provided on a second surface side of the substrate, wherein the first coil antenna and the second coil antenna are configured so as to have a same degree of electromagnetic coupling with respect to the primary antenna.

According to a further illustrative embodiment of the present invention, there is provided a secondary antenna unit including: a coupler to be mounted on a communication device including a primary antenna; and first and second secondary antennas connected to the coupler. The coupler includes: a substrate which configures a coupler main body; a first coil antenna which is connected to the first secondary antenna and provided on a first surface side of the substrate; and a second coil antenna which is connected to a second secondary antenna and provided on a second surface side of the substrate. The first coil antenna and the second coil antenna are configured so as to have a same degree of electromagnetic coupling with respect to the primary antenna when the coupler is mounted on the communication device.

### BRIEF DESCRIPTION OF THE DRAWINGS

The above and other aspects of the present invention will become more apparent and more readily appreciated from the following description of exemplary embodiments of the present invention taken in conjunction with the attached drawings, in which:

FIG. 1 is a system configuration diagram illustrating an example of the entire configuration of a communication system according to an illustrative embodiment of the present invention;

FIG. 2 is a functional block diagram of the communication system;

FIGS. 3A and 3B are plan views illustrating an example of a coupler according to an illustrative embodiment of the present invention;

FIG. 4 is a schematic sectional view illustrating a case where the coupler shown in FIGS. 3A and 3B is provided on a communication device;

FIG. 5 is a schematic view illustrating an example of magnetic field generated by the coupler;

FIGS. 6A and 6B are plan views illustrating another example of a coupler according to an illustrative embodiment of the present invention;

FIG. 7 is a schematic sectional view illustrating a case where the coupler of FIGS. 6A and 6B is provided on a communication device;

FIGS. 8A and 8B are plan views illustrating a further example of a coupler according to an illustrative embodiment of the present invention;

FIG. 9 is a schematic sectional view illustrating the coupler taken along line IX-IX shown in FIG. 8B;

FIGS. 10A and 10B are plan views illustrating a case where the coupler according to an illustrative embodiment of the present invention is provided on a communication device; and

FIG. 11 is a schematic sectional view illustrating a case where a coupler according to a modified example is provided on a communication device.

### DETAILED DESCRIPTION

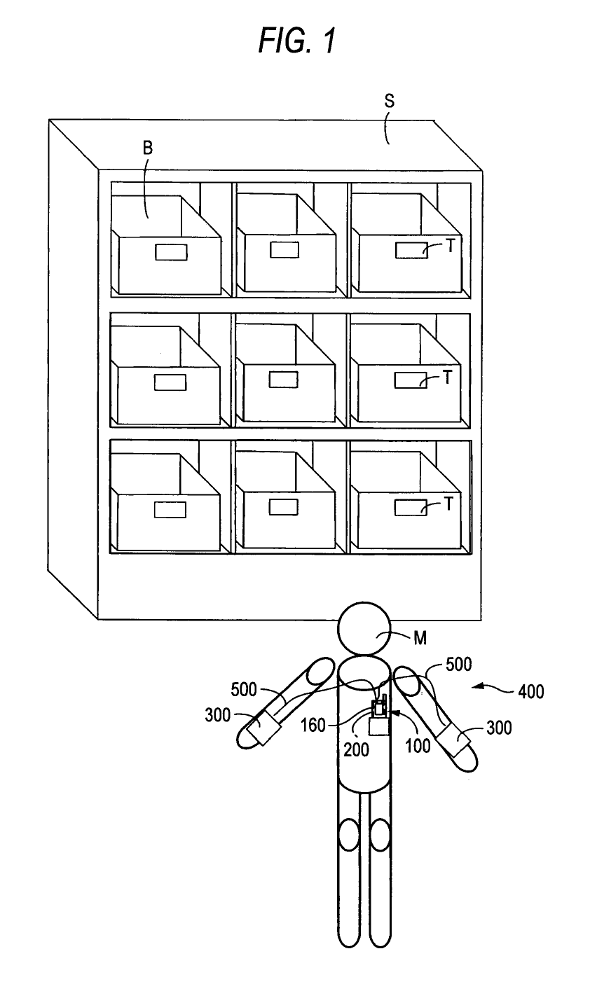

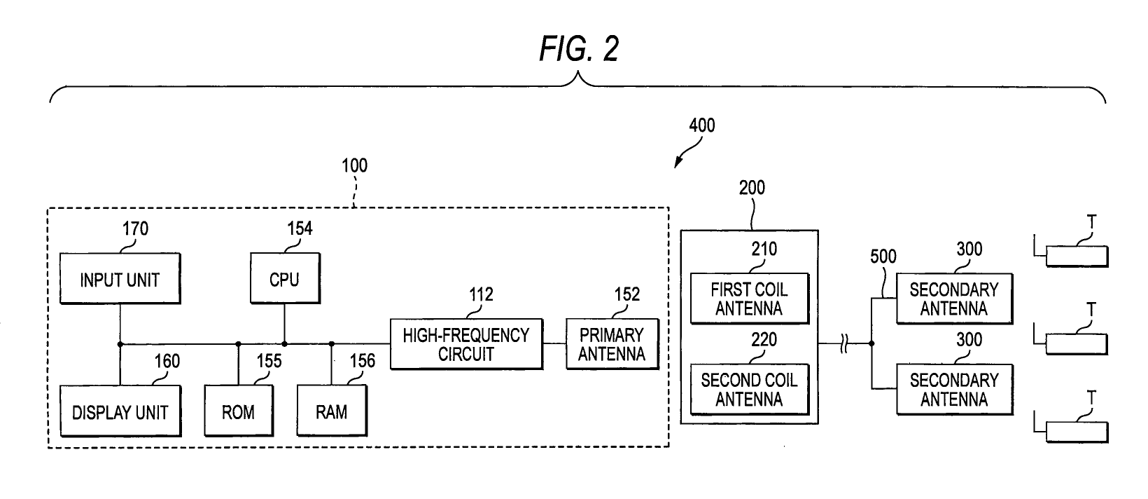

Hereinafter, illustrative embodiments of the present invention will be described with reference to the accompanying drawings. In a wireless communication system 400 of FIGS. 1 and 2, a wireless tag communication device 100 on which a coupler 200 according to an illustrative embodiment is provided. The wireless tag communication device 100 includes a primary antenna 152 that is a device antenna, and the primary antenna 152 is coupled to two secondary antennas 300 in an electromagnetic coupling method via the coupler 200, so that the transmission/reception of information with a wireless tag T is performed.

The wireless communication system 400 of FIG. 1 includes the coupler 200 provided between the primary antenna 152 and the two secondary antennas 300. The wireless communication system 400 is used for goods management such as sales, logistics, distribution, factories, and the like (see FIG. 2). For example, a worker M has the wireless tag communication device 100 in a chest pocket, and the secondary antennas 300 are provided on both hands of the worker. The secondary antennas 300 are connected to the coupler 200 which is provided on the wireless tag communication device 10, via lead wires 500. The secondary antennas 300 are provided on wrist hands or working gloves.

Specifically, plural storage boxes B are put on a goods storing shelf S, and a wireless tag T having a different ID is provided on each storage box B. Also, various kinds of goods (not illustrated) are contained in the storage boxes B. The ID of the wireless tag T is associated with information (manufacturing date, lot number, and the like) of the goods contained in the storage box B, and is read through the secondary antennas 300 provided on both hands of the worker M when the worker M takes a desired goods item out of the storage box B. Accordingly, the information of the goods taken out of the storage box B can be specified, and the information is displayed on a display unit 160 or notified by a notification unit (not illustrated).

Since the two secondary antennas 300 have the same communication range, the worker M can perform the work by equally operating both arms without caring the communication range of the secondary antennas. Also, reading omissions caused by the different communication ranges of the secondary antennas can be reduced, which causes increase in the work efficiency. Hereinafter respective components in the wireless communication system will he described.

With reference to FIG. 2, the configuration of the wireless tag communication system 400 will be described. The wireless tag communication device 100 includes a high-frequency circuit 112 that processes signals read from the wireless tag T through the secondary antennas 300 and the primary antenna 152. The wireless tag communication device 100 further includes a Central Processing Unit (CPU) 154, a Random Access Memory (RAM) 156 and a Read Only Memory (ROM) 155 as storage unit, which are electrically connected via a bus.

The high-frequency circuit 112 generates a carrier signal for the wireless tag T operating. In order to perform communication with the wireless tag T, the high-frequency circuit 112 generates a transmission command to the wireless tag T based on an instruction from the CPU 154, modulates the carrier signal to transmit the carrier signal as a high-frequency signal, and receives and demodulates the high-frequency signal modulated in the wireless tag T to transmit the demodulated signal to the CPU 154.

The CPU 154, while using a temporary storage function of the RAM 156, controls the entire wireless tag communication device 100 by performing a signal process according to a program pre-stored in the ROM 155. Also, the wireless tag communication device 100 includes an input unit 170 such as ten keys (numeral keys) through which operator's instructions and information are input, and a display unit 160 which displays information or a message.

The primary antenna 152 is provided near the surface of a device main body portion of the wireless tag communication device 100. In the case where the secondary antennas 300 are not mounted on the wireless tag communication device 100 by the coupler 200, the wireless tag communication device 100 communicates with the wireless tag T through the primary antenna 152.

In the case where the secondary antennas 300 are mounted on the wireless tag communication device 100 via the coupler 200, the secondary antennas 300 performs transmission/reception of signals with the wireless tag T in the wireless tag communication system 400. In this illustrative embodiment of the present invention, two secondary antennas 300 are provided.

The coupler 200 corresponding to the two secondary antennas 300 has a first coil antenna 210 and a second coil antenna 220 for performing transmission/reception of a high-frequency signal with respect to the secondary antennas. In the case where the coupler 200 is mounted on the wireless tag communication device 100, the wireless tag communication device 100 operates as follows. That is, the primary antenna 152 generates a magnetic field in a communicable area by electric energy of the received radio wave, and is electromagnetically coupled to the coupler 200 by the mutual induction based on the magnetic field.

The first coil antenna 210 and the second coil antenna 220 of the coupler 200 generate induced current by the mutual induction. As the induced current flows to the secondary antennas 300 connected through coaxial cables or the like, the high-frequency signal from the high-frequency circuit 112 is supplied thereto. The secondary antennas 300 resonate with the frequency of the high-frequency signal supplied from the coupler 200, and transmit the high-frequency signal to the wireless tag T.

On the other hand, when receiving a response signal from the wireless tag T, the induced current that flows through the secondary antennas 300 is changed by a modulated signal of the wireless tag T, and due to this change, the magnetic field generated from the first coil antenna 210 or the second coil antenna 220 of the coupler 200 also changes. Accordingly, the current that flows through the primary antenna 152 of the wireless tag communication device 100 that is electromagnetically coupled by the mutual induction also changes. This current change is demodulated by the high-frequency circuit 112, and is transmitted to the CPU 154 as the received signal.

Herein, the communication range of the secondary antennas 300 is an area which is determined by the distance that the high-frequency signal output from the secondary antennas 300 can reach. If the degrees of electromagnetic coupling of the first coil antenna 210 and the second coil antenna 220 with respect to the primary antenna 152 are different from each other, the amounts of induced current flowing through the respective coil antennas are also different from each other, resulting in a different in the communication range among the secondary antennas 300.

Accordingly, in order to make the communication ranges of the respective secondary antennas 300 equal to each other, it is necessary to make the degrees of electromagnetic coupling of the respective coil antennas 210 and 220 with respect to the primary antenna 152 equal to each other. The configuration of coupler 200 will be described hereinafter.

<Differentiate the Opening Area of the Coil Antenna>

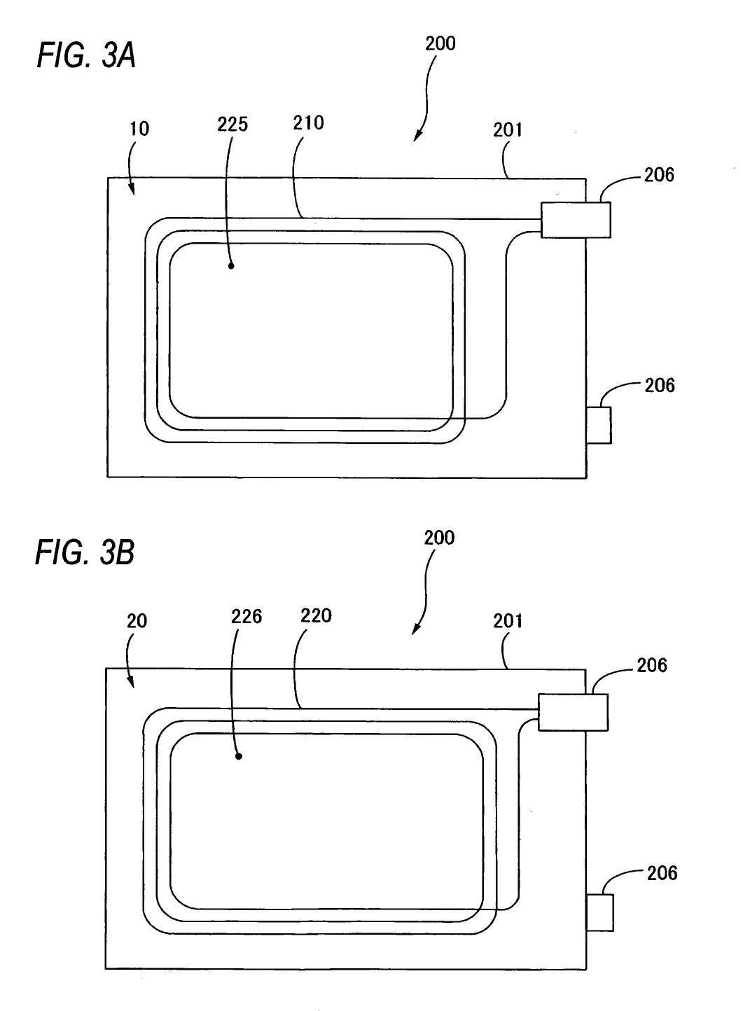

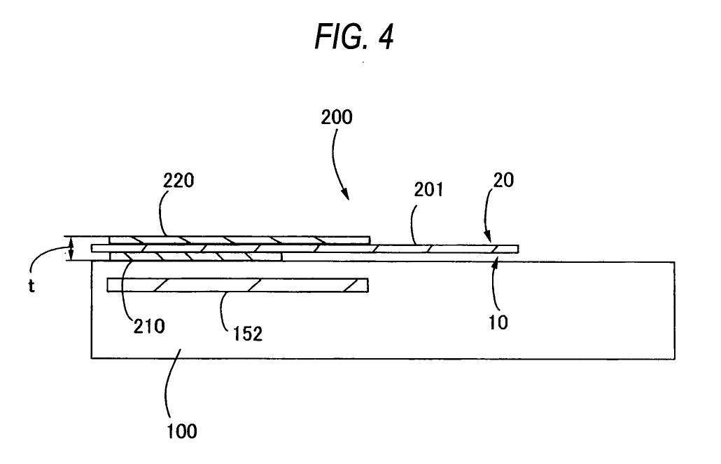

Referring to FIGS. 3A, 3B and FIG. 4, the configuration of the coupler 200 according to this illustrative embodiment of the present invention will be described. The coupler 200 includes a substrate 201 configuring the coupler 200, a first coil antenna 210 (see FIG. 3A) formed by printing on a first surface side 10 of the substrate 201, and a second coil antenna 220 (see FIG. 3B) formed by printing on a second surface side 20 of the substrate 201. The first coil antenna 210 and the second coil antenna 220 are connected to the corresponding secondary antennas 300, respectively, via lead wires (not illustrated) connected to terminals 206.

In the case where the coupler 200 is mounted on the wireless tag communication device 100 as shown in FIG. 4, it is assumed that the surface of the substrate 201 of the coupler 200 that is closer to the primary antenna 152 provided on the wireless tag communication device 100 is a first surface 10, and the surface of the substrate 201 that is farther from the primary antenna 152 than the first surface 10 is a second surface 20. The thicknesses of conductor wires constituting the respective antenna coils are the same.

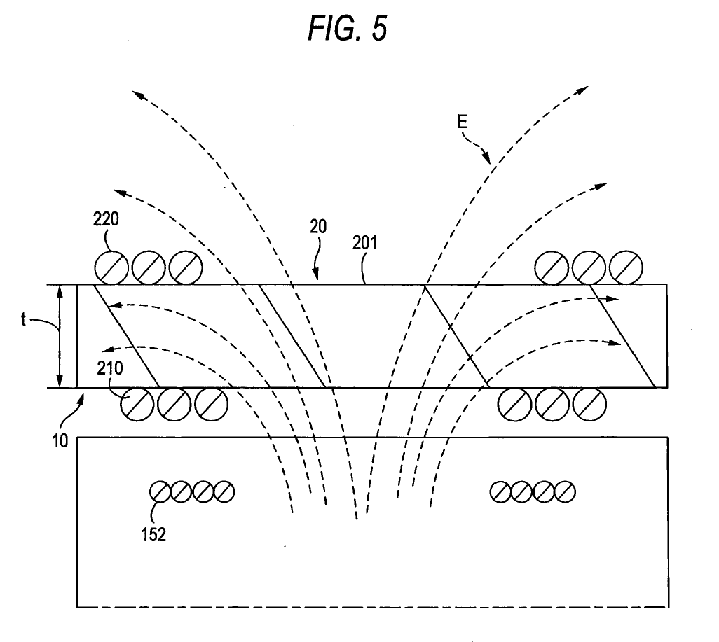

Here, as shown in FIG. 5, the first coil antenna 210 formed on the first surface side 10 of the substrate 201 and the second coil antenna 220 formed on the second surface side 20 have different distances from the primary antenna 152 by a thickness t of the substrate 201. Accordingly, as shown in FIG. 5, the amount of linkage magnetic flux of the radio wave signal output from the primary antenna 152 is different between the first surface 10 and the second surface 20. As a result, even though the first coil antenna and the second coil antenna have the same configuration, if these are provided on the first surface and the second surface, respectively, the coupling degrees of the first coil antenna and the second coil antenna with respect to the primary antenna 152 are different from each other.

In this illustrative embodiment, as shown in FIGS. 3A and 3B, an opening 225 of the first coil antenna 210 that is provided on the first surface side 10 closer to the primary antenna 152 and an opening 226 of the second coil antenna 220 that is provided on the second surface side 20 are formed so that the opening area (see FIG. 3A) of the opening 225 of the first coil antenna 210 is smaller than the opening area (see FIG. 3B) of the opening 226 of the second coil antenna 220.

The induced current I(A) of the coil antenna is in proportion to the multiplication of the magnetic field, strength H(A/m) flux-linking the coil antenna, the number N of windings of the coil antenna, and the opening area A(m²) of the coil antenna. Accordingly, if it is intended to make the induced currents of the antenna coils having different magnetic field strengths equal to each other, for example, it is necessary to adjust the numbers of windings of the respective coil antennas in the case where the opening areas of the coil antennas are equal to each other, while it is necessary to adjust the opening areas or the respective coil antennas in the case where the numbers of windings of the coil antennas are equal to each other.

As shown in FIG. 5, the magnetic field E generated from the primary antenna of the wireless tag communication device 100 is relatively stronger on the side of the first coil antenna 210 provided on the first surface side 10 in comparison to the side of the second coil antenna 220 provided on the second surface side 20. Accordingly, by making the opening area of the opening 225 of the first coil antenna 210, at which the magnetic field is stronger, smaller than the opening area of the opening 226 of the second coil antenna 220, the induced currents induced in the first coil antenna 210 and the second coil antenna 220 can be equal to each other, and the coupling degrees of the first coil antenna 210 and the second coil antenna 220 with respect to the primary antenna 152 can become equal to each other (see FIG. 4). Therefore, the high-frequency signal output from the primary antenna 152 can be transmitted to the plurality of secondary antennas 300 to provide same information communication range. Accordingly, for example, in the case where a worker performs reading of the wireless tag using this communication system 400, reading omissions caused by the different communication ranges of the secondary antennas 300 can be reduced.

In this case, it is assumed that the numbers of windings of the first coil antenna 210 and the second coil antenna 220 and the thicknesses of the conductor wires constituting the coil antennas are equal to each other, respectively. Also, the sizes of the opening areas of the first coil antenna 210 and the second coil antenna 220 are appropriately adjusted in accordance with the thickness of the substrate or the position relation between the primary antenna and the first and second coil antennas 210 and 220.

<Differentiate the Numbers of Windings of the Coil Antennas>

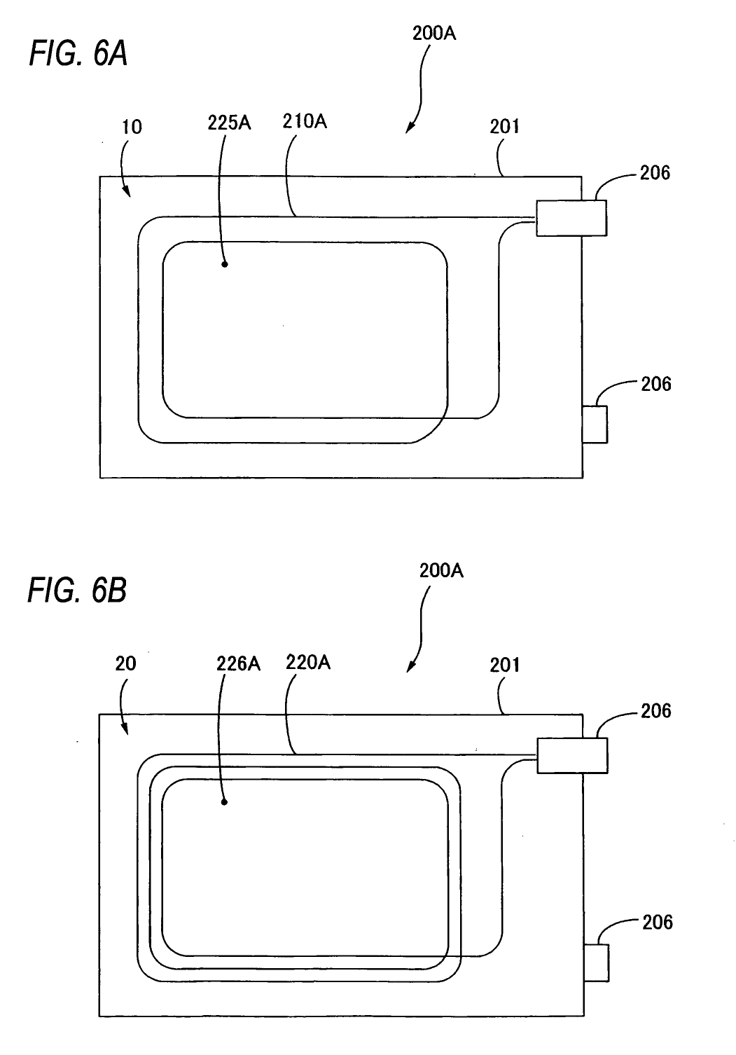

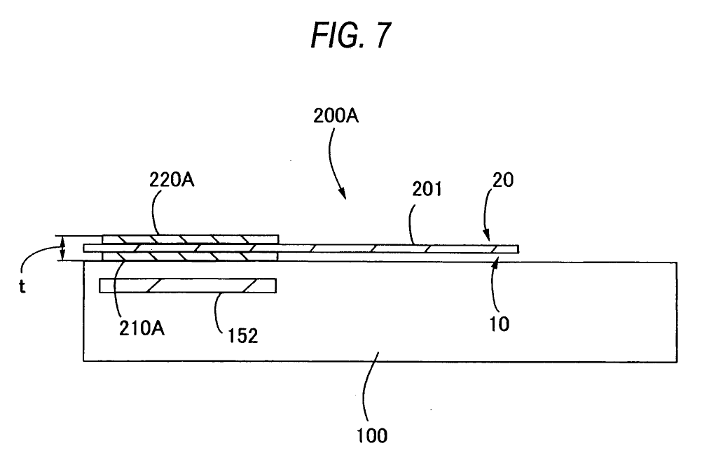

Referring to FIGS. 6A and 6B, and FIG. 7, the configuration of a coupler 200A according to another illustrative embodiment of the present invention will be described. The same reference numerals as in FIGS. 3A and 3B, and FIG. 4 are used for the same elements, and the detailed explanation thereof will be omitted. In this illustrative embodiment, comparing the number of windings of the first coil antenna 210A (see FIG. 6A) which is provided on the first surface side 10 that is closer to the primary antenna 152 with the number of windings of the second coil antenna 220A (see FIG. 6B) which is provided on the second surface side 20, the number of windings of the first coil antenna 210A is smaller than that of the second coil antenna 220A. In this case, it is assumed that the opening areas of the openings 225A and 226A of the coil antennas are equal to each other.

As described above with reference to FIG. 5, the magnetic field E generated by the radio wave signal from the primary antenna 152 of the wireless tag communication device 100 is relatively stronger on the first surface side 10 in comparison to the second surface side 20. Accordingly, by making the number of windings of the first coil antenna 210A, on which the magnetic field is relatively stronger, smaller than the number of windings of the second coil antenna 220A, the induced currents induced in the first coil antenna 210A and the second coil antenna 220A can he equal to each other. Accordingly, the coupling degrees of the first coil antenna 210A and the second coil antenna 220A to the primary antenna 152 can become equal to each other (see FIG. 7). Therefore, the high-frequency signal output from the primary antenna 152 can be transmitted to the plurality of secondary antennas 300 to provide same information communication range. Accordingly, for example, in the case where a worker performs reading of the wireless tag using this communication system 400, reading omissions caused by the different communication ranges of the secondary antennas 300 can be reduced.

In this case, it is assumed that the opening areas of the openings 225A and 226A of the first and second coil antennas 210A and 220A and the thicknesses of the conductor wires constituting the coil antennas are equal to each other, respectively. Also, the number of windings of the first coil antenna 210A and the number of windings of the second coil antenna 220A are appropriately adjusted in accordance with the thickness of the substrate or the position relation between the primary antenna and the first and second coil antennas 210A and 220A.

<Providing the First Coil Antenna and the Second Coil Antenna on Both Sides of the First Surface and the Second Surface>

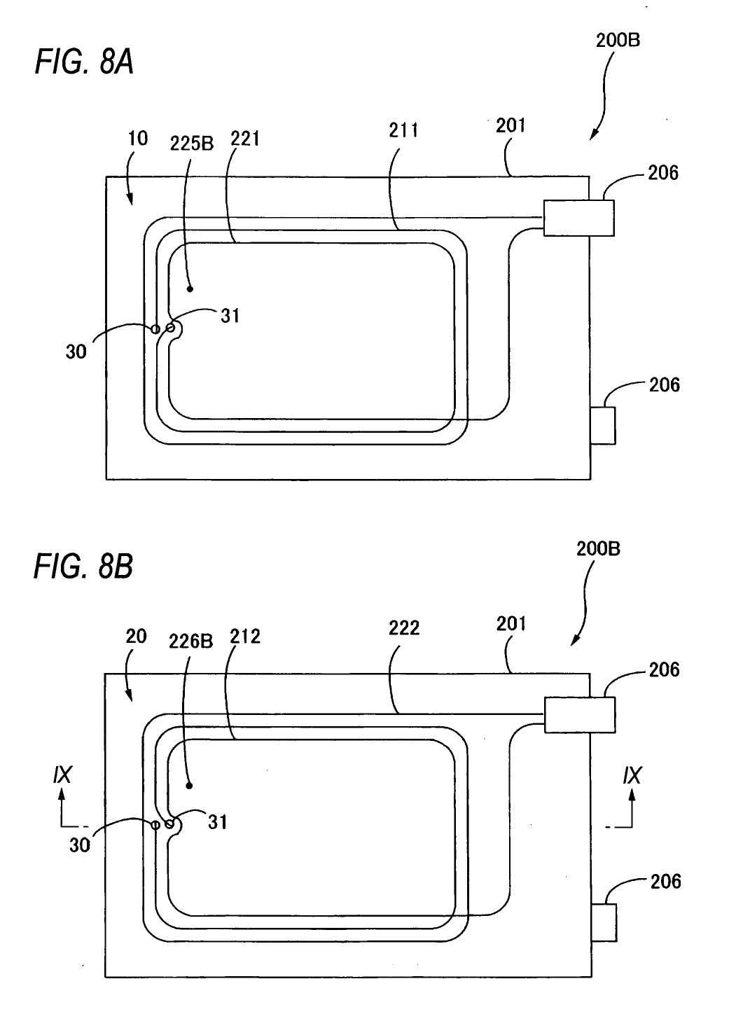

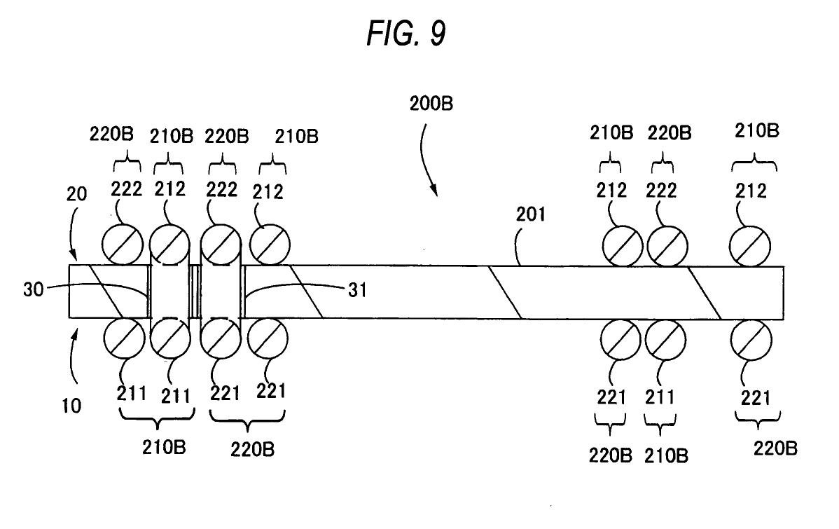

Referring to FIGS. 8A and 8B, and FIG. 9, the configuration of a coupler 200B according to a further illustrative embodiment of the present invention will be described. The same reference numerals as in FIGS. 3A and 3B, and FIG. 4 are used for the same elements, and the detailed explanation thereof will be omitted. In this illustrative embodiment, as shown in FIG. 9, in the case where the coupler 200B is mounted, the first coil antenna 210B includes a first-surface-side first coil antenna portion 211 (see FIG. 8A), which is provided on the first surface side 10 that is a surface closer to the primary antenna 152, and a second-surface-side first coil antenna portion 212 (see FIG. 8B), which is drawn from a through-hole 30 and is provided on the second surface side.

Also, in FIG. 9, the second coil antenna 220B includes a first-surface-side second coil antenna portion 221 (see FIG. 8A), which is provided on the first surface side 10, and a second-surface-side second coil antenna portion 222 (see FIG. 8B), which is drawn from a through-hole 31 and is provided on the second surface side. It is noted that the first-surface-side first coil antenna portion 211 and the first-surface-side second coil antenna portion 221 have substantially same number of windings and same opening area 225B, and the second-surface-side first coil antenna portion 212 and the second-surface-side second antenna coil portion 222 have substantially same number of windings and same opening area 226B.

As described above, although the strength of the magnetic field generated from the primary antenna 152 of the wireless tag communication device 100 on the first surface side 10 is different from that on the second surface side 20, the first coil antenna 210B has the first-surface-side first coil antenna portion 211 and the second-surface-side first coil antenna portion 212, and the second coil antenna 220B has the first-surface-side second coil antenna portion 221 and the second-surface-side second coil antenna portion 222.

Since the first-surface-side first coil antenna portion 211 and the first-surface-side second coil antenna portion 221 provided on the first surface side 10 have substantially same opening area, the same number of windings, and the same distance from the primary antenna 152, the amounts of induced current are substantially equal to each other. Additionally, the second-surface-side first coil antenna portion 212 and the second-surface-side second coil antenna portion 222 provided on the second surface side 20 have substantially same amount of induced current. Accordingly, the induced currents induced in the first coil antenna 210B and the second coil antenna 220B can be equal to each other.

Accordingly, the induced currents induced in the first coil antenna 210B and the second coil antenna 220B can be made equal to each other more accurately, and therefore, the high-frequency signal output from the primary antenna 152 can be transmitted to the plurality of secondary antennas 300 to provide same information communication range. Therefore, for example, in the case where a worker performs reading of the wireless tag using this communication system 400, reading omissions caused by the different communication ranges of the secondary antennas 300 can be reduced.

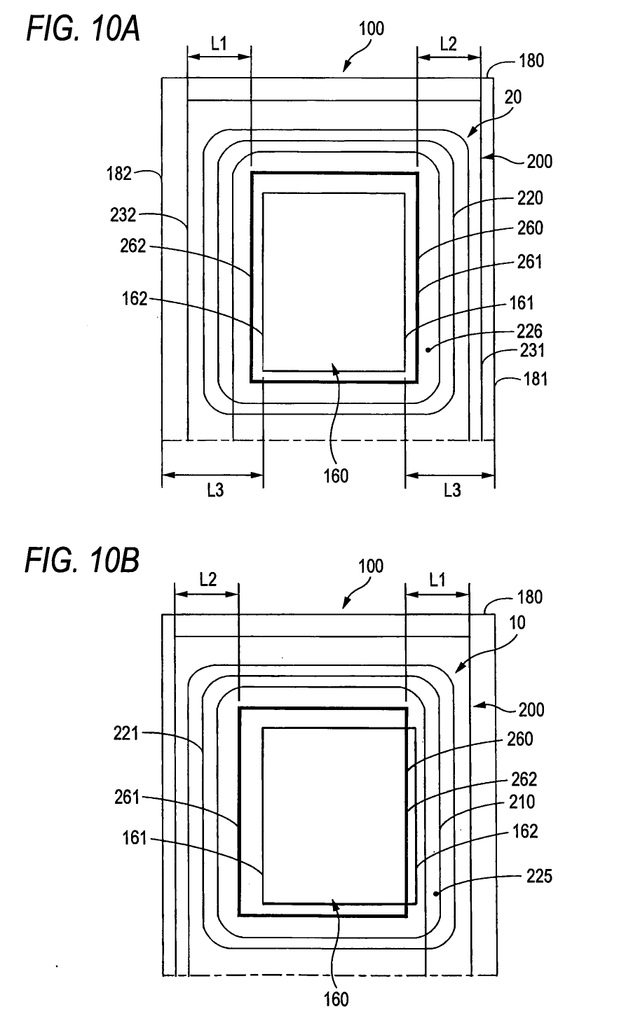

Referring to FIG. 10A, the configuration of a case where the coupler 200 is mounted on the wireless tag communication device 100. The wireless tag communication device 100 of this illustrative embodiment is provided with a display unit 160 on the surface of a device main body portion 180, and in the case where the coupler 200 is mounted on the wireless tag communication device 100, the entire of the display unit 160 is exposed through a window portion 260 formed in the coupler 200. It is assumed that the primary antenna 152 is provided closer to the display unit 160.

The window portion 260 is formed inside an opening of the first coil antenna (not illustrated) provided in the coupler 200 and an opening 226 of the second coil antenna 220. As an example, the position relations among the wireless tag communication device 100, the display unit 160, and the window portion 260 of the coupler 200 in left and right directions in FIGS. 10A and 10B are as follows. In FIGS. 10A and 10B, the window portion 260 is indicated by a thick line.

It is assumed that the distance from a left end 182 of the device main body portion 180 of the wireless tag communication device 100 to a left end 162 of the display unit 160 is L3, and the distance from a right end 181 of the device main body portions 180 to a right end 161 of the display unit 160 is also L3. Additionally, if it is assumed that the distance from a left end 262 of the window portion 260 to a left end 232 of the coupler 200 is L1, and the distance from a right end 261 of the window portion 260 to a right end 231 of the coupler 200 is L2, the relation of L3>L1>L2 are satisfied.

Accordingly, if the first surface 10 of the substrate 201 of the coupler 200 is mounted to face the side where the display unit 160 of the wireless tag communication device 100 is provided, the display unit 160 is entirely exposed through the window portion 260. In contrast, if the second surface 20 of the substrate 201 of the coupler 200 is mounted to face the side where the display unit 160 of the wireless tag communication device 100 is provided, due to position relation between the display unit 160 and the window portion 260 of the coupler 200, a part of the display unit 160 is not exposed through the window portion 260 (see FIG. 10B). Therefore, the erroneous mounting state can be easily recognized.

In this illustrative embodiment, as shown in FIGS. 10A and 10B, the distances from the ends in left and right directions of the window portion 260 of the coupler 200 to the display unit 160 are set to be different from each other. However, the distances from the ends in the upper and lower direction of the window portion 260 of the coupler 200 to the display unit 160 may be set to be different from each other. Also, in the case where the display unit 160 and the window portion 260 are in the shape of a circle or an ellipse, the center position of the window portion 260 is set to be different from the center position of the display unit 160. In this case, if the coupler 200 is arranged opposite to a specified side of the device main body portion 160, the entire display unit 160 is exposed through the window portion 260.

Additionally, even in the case where the display unit 160 and the window portion 260 have another different shape, if the coupler 200 is arranged opposite to a specified side of the device main body portion 160, the entire display unit 160 can be exposed through the window portion 260.

<Three or More Secondary Antennas>

In the above-described illustrative embodiment, it is exemplified that two secondary antennas 300 are provided, and the coupler 200 is provided with the first coil antenna 210 and the second coil antenna 220 corresponding to such secondary antennas. However, three or more secondary antennas 300 may be provided,

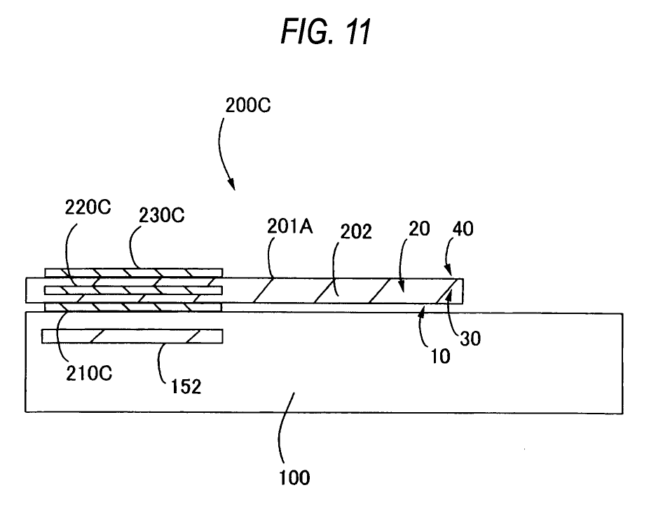

For example, in the case where three secondary antennas 300 are provided, as shown in FIG. 11, a coupler 200C includes a multilayer substrate 201A. A first coil antenna 210C is provided on a surface that is closest to the primary antenna 152 of the wireless tag communication device 100, a second coil antenna 220C is provided on the middle layer, and a third coil antenna 230C is provided on a surface that is opposite to the surface where the first coil antenna 210C is provided.

In this case, as described above, the first coil antenna 210C that is closest to the primary antenna has the largest magnetic field strength, and the third coil antenna 230C that is farthest from the primary antenna has the smallest magnetic field strength. The relation between the first coil antenna 210C and the second coil antenna 220C, the relation between the second coil antenna 220C and the third coil antenna 230C, or the relation between the first coil antenna 210C and the third coil antenna 230C are equal to the relation between the fast coil antenna and the second coil antenna in this illustrative embodiment.

Accordingly, in order to make the induced currents induced to the first coil antenna 210C, the second coil antenna 220C, and the third coil antenna 230C equal to one another, the first coil antenna 210C, the second coil antenna 220C, and the third coil antenna 230C are formed so as to provide the above-described relation between the configuration of the first coil antenna 210 and the configuration of the second coil antenna 220 in the coupler 200 or the above-described relation between the configuration of the first coil antenna 210A and the cont of the second coil antenna 220A in the coupler 200A.

In this case, in accordance with the thickness of the substrate and the distances between the respective surfaces, the numbers of windings or the opening areas of the first coil antenna 210C, the second coil antenna 220C, and the third coil antenna 230C are determined.

Further, even in the case where more than three secondary antennas are provided, the relation between one coil antenna and another arbitrary coil antenna provided in the coupler is same as that in the above, and one coil antenna and another coil antenna are so formed as to have the configurations of the above-described illustrative embodiments.

In the above-described illustrative embodiments, it is sufficient if the first coil antenna 210 and the second coil antenna 220 are substantially provided on the first surface 10 and the second surface 20 to have the configurations of the illustrative embodiments, and for some reasons such as drawing of the connection terminal 260 and so on, a part of the antennas may be provided on a different surface.

Further, in the above-described illustrative embodiments, it is exemplified that in order to cause the same amount of current to be induced in the respective antenna coils provided on the first surface and the second surface, the numbers of windings of the coil antennas are changed if the respective coil antennas have the same opening area, while the opening areas of the coil antennas are changed if the respective coil antennas have the same number of windings. However, both the number of windings and the opening area of the coil antennas may be changed so that the multiplication of the number of windings and the opening area of the coil antenna that is provided in a position having a smaller magnetic field strength becomes larger than the multiplication of the number of windings and the opening area of the coil antenna that is provided in a position having a larger magnetic field strength.

While the wireless tag communication device 100 has been described as an example of the communication device, the communication device may be any other communication device that performs wireless communication.

Additionally, while the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. A coupler to be provided between a primary antenna provided in a communication device and a plurality of secondary antennas, the coupler comprising:
a substrate which configures a coupler main body;
a first coil antenna which is connected to a first secondary antenna and provided on a first surface side of the substrate; and
a second coil antenna which is connected to a second secondary antenna and provided on a second surface side of the substrate,
wherein the first coil antenna and the second coil antenna are configured so as to have a same degree of electromagnetic coupling with respect to the primary antenna.

2. The coupler according to claim 1,
wherein the coupler is configured to be mounted on the communication device such that the first surface side provided with the first coil antenna is closer to the primary antenna than the second surface side provided with the second coil antenna,
wherein at least (i) an opening area of the first coil antenna is smaller than an opening area of the second coil antenna, or (ii) a number of windings of the first coil antenna is smaller than a number or windings of the second coil antenna.

3. The coupler according to claim 2, further comprising:
a window portion formed inside an opening of the first coil antenna and an opening of the second coil antenna, and
wherein the window portion is formed such that an entire of a display unit provided on the communication device is exposed through the window portion when the coupler is mounted on the communication device while the first surface is closer to the primary antenna than the second surface, and that a part of the display unit is not exposed though the window portion when the coupler is mounted on the communication device while the first surface is further to the primary antenna than the second surface.

4. A coupler to be provided between a primary antenna provided in a communication device and a plurality of secondary antennas, the coupler comprising:
a substrate which configures a coupler main body and includes a first surface and a second surface;
a first coil antenna which is connected to a first secondary antenna and includes a first portion provided on the first surface side and a second portion provided on the second surface side; and
a second coil antenna which is connected to a second secondary antenna and includes a first portion provided on the first surface side and a second portion provided on the second surface side,
wherein the first coil antenna and the second coil antenna are configured so as to have a same degree of electromagnetic coupling with respect to the primary antenna.

5. The coupler according to claim 4,
wherein the first portion of the first coil antenna and the first portion of the second coil antenna have a substantially same number of windings and a substantially same opening area, and
wherein the second portion of the first coil antenna and the second portion of the second coil antenna have a substantially same number of windings and a substantially same opening area.

6. A communication system comprising:
a communication device including a primary antenna configured to transmit and receive information; and
a coupler provided between the primary antenna and a plurality of secondary antennas,
wherein the coupler including:
a substrate which configures a coupler main body;
a first coil antenna which is connected to a first secondary antenna and provided on a first surface side of the substrate; and
a second coil antenna which is connected to a second secondary antenna and provided on a second surface side of the substrate,
wherein the first coil antenna and the second coil antenna are configured so as to have a same degree of electromagnetic coupling with respect to the primary antenna.

7. The communication system according to claim 6,
wherein the coupler is configured to be mounted on the communication device such that the first surface side provided with coil antenna is closer to the primary antenna than the second surface side provided with the second coil antenna,
wherein at least (i) an opening area of the first coil antenna is smaller than an opening area of the second coil antenna or (ii) a number of windings of the first coil antenna is smaller than a number of windings of the second coil antenna,
wherein the coupler further includes a window portion formed inside art opening of the first coil antenna and an opening of the second coil antenna, and
wherein the window portion is formed such that an entire of a display unit provided on the communication device is exposed through the window portion when the coupler is mounted on the communication device while the first surface is closer to the primary antenna than the second surface, and that a part of the display unit is not exposed though the window portion when the coupler is mounted on the communication device while the first surface is further to the primary antenna than the second surface.
